(19) United States
(12) Patent Application Publication
(10) Pub. No.: US 2019/0236564 A1
(43) Pub. Date: Aug. 1, 2019

(54) SYSTEM AND METHOD FOR DIGITAL CURRENCY VIA BLOCKCHAIN

(71) Applicant: Walmart Apollo, LLC, Bentonville, AR (US)

(72) Inventors: Robert CANTRELL, Herndon, VA (US); David M. NELMS, Rogers, AR (US); John J. O'BRIEN, Farmington, AR (US); Brian MCHALE, Oldham (GB)

(73) Assignee: Walmart Apollo, LLC, Bentonville, AR (US)

(21) Appl. No.: 16/260,616

(22) Filed: Jan. 29, 2019

Related U.S. Application Data
(60) Provisional application No. 62/624,721, filed on Jan. 31, 2018.

(51) Int. Cl. G06Q 20/06; G06Q 20/38

(52) U.S. Cl. CPC G06Q 20/0658; G06Q 20/389

(57) ABSTRACT

A method include: generating one digital currency unit by tying the one digital currency unit to a regular currency; storing information of the one digital currency unit into a block of a blockchain; buying or paying the one digital currency unit; determining whether restrictions are applied to the one digital currency unit by referring to one or more documents associated with the one digital currency; recording the determination in a block of the blockchain; overlaying the one digital currency unit with customer purchase history; calculating savings based on the one digital currency unit again naked forecast; applying the savings to customer purchases; using the one digital currency unit for accepted goods or services with the saving if the one digital currency unit is restricted; using the one digital currency unit for any goods or services with the saving if the one digital currency unit is unrestricted; and storing the one digital currency into a digital currency reserve.

### BACKGROUND

### 1. Technical Field

The present disclosure relates to digital currency, and more specifically to systems and methods for providing digital currency via blockchain.

### 2. Introduction

Digital currency may refer to a type of currency available in digital form. Digital currency may include virtual currencies and cryptocurrencies. Like physical money, digital currencies may be used to buy any physical goods and services, but may also be restricted to certain communities and certain items that can be purchased. Digital currency may also a money balance recorded electronically on a stored-value card or other devices. Digital currency may allow for the transfer of value on computer networks, such as the Internet. Further digital currency can either be centralized, or decentralized.

Blockchain is a shared and distributed ledger that may facilitate the process of recording transactions and tracking assets in a peer-to-peer network. An asset may be tangible (e.g., a house, a car, and so on). An asset may also be intangible like digital currency. An existing computer system of digital currency may not accurately track digital currency transfer, thus causing inefficiencies of the existing computer system. A blockchain-based system of providing digital currency may facilitate accurately and efficiently transferring digital currency and reduce disputes among different parties.

The Blockchain-based system and method of providing digital currency may further provide some advantages. For example, many people are from low-income households where credit can be a problem and carrying cash can be problematic. Keeping and accessing cash can be expensive for low income households simply because those customers may live week to week and may have little cash in their bank accounts—if they have bank accounts. The cost of having little money is high because of frequent short-term borrowing, accumulated interest on short-term borrowing that becomes long-term, high bank fees proportional to wealth, high credit card fees, and high payday loan interests, all of which can take money away that could be available—and would be used—to buy necessities. Providing digital currency based on blockchain may overcome the drawbacks associated with the low-income househlods.

### SUMMARY

A method for performing concepts disclosed herein can include: generating one digital currency unit by tying the one digital currency unit to a regular currency; storing information of the one digital currency unit into a block of a blockchain; buying or paying the one digital currency unit; determining whether restrictions are applied to the one digital currency unit by referring to one or more documents associated with the one digital currency; recording the determination in a block of the blockchain; overlaying the one digital currency unit with customer purchase history; calculating savings based on the one digital currency unit again naked forecast; applying the savings to customer purchases; using the one digital currency unit for accepted goods or services with the saving if the one digital currency unit is restricted; using the one digital currency unit for any goods or services with the saving if the one digital currency unit is unrestricted; and storing the one digital currency into a digital currency reserve.

A system configured as disclosed herein can include: a processor; and a computer-readable storage medium having instructions stored which, when executed by the processor, cause the processor to perform operations comprising: generating one digital currency unit by tying the one digital currency unit to a regular currency; storing information of the one digital currency unit into a block of a blockchain; buying or paying the one digital currency unit; determining whether restrictions are applied to the one digital currency unit by referring to one or more documents associated with the one digital currency; recording the determination in a block of the blockchain; overlaying the one digital currency unit with customer purchase history; calculating savings based on the one digital currency unit again naked forecast; applying the savings to customer purchases; using the one digital currency unit for accepted goods or services with the saving if the one digital currency unit is restricted; using the one digital currency unit for any goods or services with the saving if the one digital currency unit is unrestricted; and storing the one digital currency into a digital currency reserve.

A non-transitory computer-readable storage medium configured as disclosed herein can have instructions stored which, when executed by a computing device, cause the computing device to perform operations which include: generating one digital currency unit by tying the one digital currency unit to a regular currency; storing information of the one digital currency unit into a block of a blockchain; buying or paying the one digital currency unit; determining whether restrictions are applied to the one digital currency unit by referring to one or more documents associated with the one digital currency; recording the determination in a block of the blockchain; overlaying the one digital currency unit with customer purchase history; calculating savings based on the one digital currency unit again naked forecast; applying the savings to customer purchases; using the one digital currency unit for accepted goods or services with the saving if the one digital currency unit is restricted; using the one digital currency unit for any goods or services with the saving if the one digital currency unit is unrestricted; and storing the one digital currency into a digital currency reserve.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates exemplary electronic currency;

FIG. 2 illustrates an exemplary electronic currency flow;

FIG. 3 illustrates an exemplary use of electronic currency on the go;

FIG. 4 illustrates a flow chart of an exemplary method of circulating electronic currency;

FIG. 5 illustrates an exemplary blockchain; and

FIG. 6 illustrates an exemplary computer system.

### DETAILED DESCRIPTION

In this disclosure, a blockchain protected digital currency may be provided. The digital currency may be pegged to the US dollar and available for use only at selected retailors or partners. In other embodiments, the digital currency is available for use anywhere. The digital currency can provide a fee-free, or fee-minimal place to store wealth that can be spent, for example, at retailers and, if needed, easily converted to cash. Such accounts could even earn interest. Digital currency may be tied to a national currency, such as the US dollar, so funds can be added or taken out easily. The digital currency value could, in some embodiment, be tied to other digital currencies.

Using a digital currency, low-income households that find banking expensive, may have an alternative way to handle wealth at an institution that can supply the majority of their day-to-day financial and product needs.

Embodiments of the invention may provide an open-platform value exchange for purchases and for crowdsource work. Customers may buy products for their households and may also buy products for others, deliver products to others, do crowdsource work—for example, be a repair technician for a few hours, an associate for a few hours, a designated shopper. These may be done seamlessly through a digital currency ecosystem, for example, a digital currency exchange platform that may be implemented according to the disclosed system and method. This digital currency ecosystem can be paired with a work board where customers, crowdsource prospects, and others can post requests and offers for work.

Digital currency could be used at selected partners, and in the ecosystem environment. Those partners may use earned digital currency to buy supplies at stores or through a supply distribution center.

In some embodiments, digital currency may remove credit and debit cards without requiring cash by offering a blockchain-protected digital currency. In some embodiments, the digital currency may act as a pre-approved biometric (e.g., fingerprint or eye pattern) credit. A person is the “credit card” to their own digital value bank.

In some embodiments, digital currency may be used for a currency micromarket. As used herein, the micromarket may refer to an unattended retail environment where consumers can purchase products from open shelves, coolers, or freezers and use a self-checkout kiosk to pay for their products. Customers without traditional bank accounts can create a microbank at an institution such as a retailer, which gains interest while their money is there. A customer buys digital currency, such as at the beginning of a month. The purchase may be made using another type of currency, dollars, Bitcoins, yen, etc. A smart analysis AI (artificial intelligence) helps the customer to buy an amount according to his budget, values, affinities, and preferences.

In some embodiment, a reward program may be created. In the reward program, for each unit of digital currency a person spends or earns, the person receives rewards toward other purchases.

In some embodiments, digital currency futures may be provided. Customers can buy digital currency and be able to buy goods at the price that exists on that day, even if prices go up—subject to limits. This could be a better way for customers to guarantee purchasing power for a period than putting money in a bank, while at the same time offering a predictable source of revenue for retailers.

In some embodiments, the digital currency may compensate for unreliability. For example, short-term, emergency loans may be offered, where the customer is charged no interest or a fair interest rate. Payment is in a digital currency good for staples such as food.

In some embodiments, retailers may be directly to aid organizations for assistance that may be used to provide goods. Retailers may tie into assistance that can provide vehicles or funding for vehicles to get goods to customers when the customers do not have efficient mobility otherwise.

In some embodiments, different features may be combined with each other, or removed entirely. In some embodiments, digital currency can offset forecast uncertainties as follows. The purchase or payment in one unit of digital currency can be logged as revenue or future revenue since it will (or would be highly likely) to be spent at a retailer versus elsewhere or exchanged. Forecasts can be further smoothed by inputting customer purchase history as a way to make more accurate forecasts, which can lead to savings (n) over naked forecasts. Some of n can go to the customer using the digital currency, which in effect makes the digital currency more valuable at the retailer than the equivalent dollar used for the exchange, a win-win for the retailer and the customer. The savings can be different by product type to factor in differences in margins and differences in the impact of improved forecasts. The savings can be greater when the customer buys goods that are on his or her shopping history and are therefore predicted, which has the added effect of helping predictions to come true, making forecasts more accurate (as noted above), and creating a larger savings, matching customer balance of ecommerce versus purchase habits, and determining that upcoming purchases will be made. For example, analysis can result in more accurate forecasts, and less waste, making inventory and ordering computer systems run more efficiently.

The analysis may be of the probability that a customer will order a given product at a given store within a given timeframe. Specifically, this may indicate a spatial, temporal, and material variable (referred to as s, t, and m, respectively) and a risk variable r that is the influences affecting the probability that a forecasted s, t, and m is true. The analysis for forecasting here may use any suitable forecasting algorithms. More accurate forecasts may indicate a risk-reduction where the degree of variance is minimized. Digital currency removes or reduces some risks in the forecasting. An example may be illustrated here as follows. A customer has $10 US dollars in his or her wallet or 10 units of a digital currency issued by a retail store, and that $10 US dollars could be spent anywhere, but the 10 units of the digital currency must be spent at the retail store. The 10 units of digital currency may be even fractionally more valuable for purchases at the retail store than the $10 US dollars. As such, it greatly reduce the risk that the forecast will be wrong because the customer spent his or her money outside of the retail store. The forecast accuracy about how much a customer will spend at the retail store goes up. That customer will most likely be the entire $10 equivalent.

The next question is what the customer will spend the money on. To improve accuracy here, the digital currency is used here to promote consistency, that a customer may receive more value if he or she buys certain items repeatedly—which itself can be influenced by standard local promotion techniques used at store to balance inventory flow. Also, if it were involved in a government assistance program, for example, where it is known when a customer will be paid, and therefore, and when that customer will likely shop, the forecasts become yet more accurate than they could be when the customers payment cycle is unknown. As forecast accuracy goes up, the cost of holding inventory to handle purchase variances goes down, and the some of that aggregate value could be used as a benefit to customers so that 10 units of digital currency has even more purchasing power than 10 equivalent US dollars.

In some embodiments, the digital currency could offer restrictions on what product categories are allowed to be bought and by whom. The digital currency could be restricted to product classes, price, or any other restriction that the owner of the currency wishes (e.g., only to be used for food purchases). The digital currency system may allow a customer to have several different tenders on file in their account. Based upon the products, the system would assign the cost to various forms of tender including WIC, TANF, digital currency, credit card, business account, etc. A set of rules may be used to assign product categories to tender. This way a single purchase by the customer could be broken down into several accounts. For example, a point of sale (POS) system may be integrated with the digital currency and may automatically charge multiple product categories to the digital currency, but may charge alcohol purchases to a credit card and perhaps small business purchases to a business account.

As an example of the set of rules, for example, in government assistance and dependent care, a government-assistance restricted currency may be good for food or even certain types of food but not alcohol or cigarettes. It may preclude the purchase of certain items a minor might otherwise purchase ranging from candy to an R-Rated DVD. Restrictions might be spatially oriented, for example, a currency a minor could use at the deli-counter, but not at the cash register, as a way to aim that currency usage toward buying lunch. It could be time oriented, also. For example, a customer might have a currency variant that has a more purchasing power if the customer shops when the store is traditionally not busy versus at common periods of rush. It could be quantity-based, for example, where a customer could buy (n) bottles of a pain reliever a week and no more.

In some embodiments, new “gift cards” enabled by the digital currency system could spend themselves before the card's 24-month life expires. The system may purchase an item for the customer based upon customer value vectors and perhaps the customer's shopping list or pending shopping cart. Multiple gift cards may be consolidated into a single digital currency account.

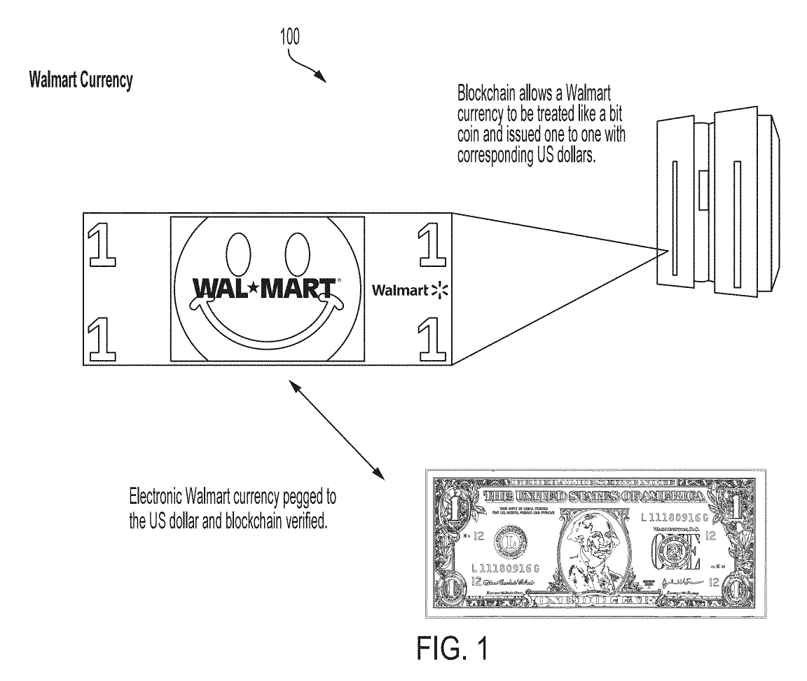

Systems, methods, and computer-readable storage media configured according to this disclosure are capable of distributing digital currency among two or more devices/parties. FIG. 1 illustrates an example digital currency 100. In this example, blockchain may be used to allow digital currency to be treated like a bitcoin. The digital currency may be issued one to one with corresponding US dollars. The currency 100 can be tied to the US dollars and can be blockchain verified.

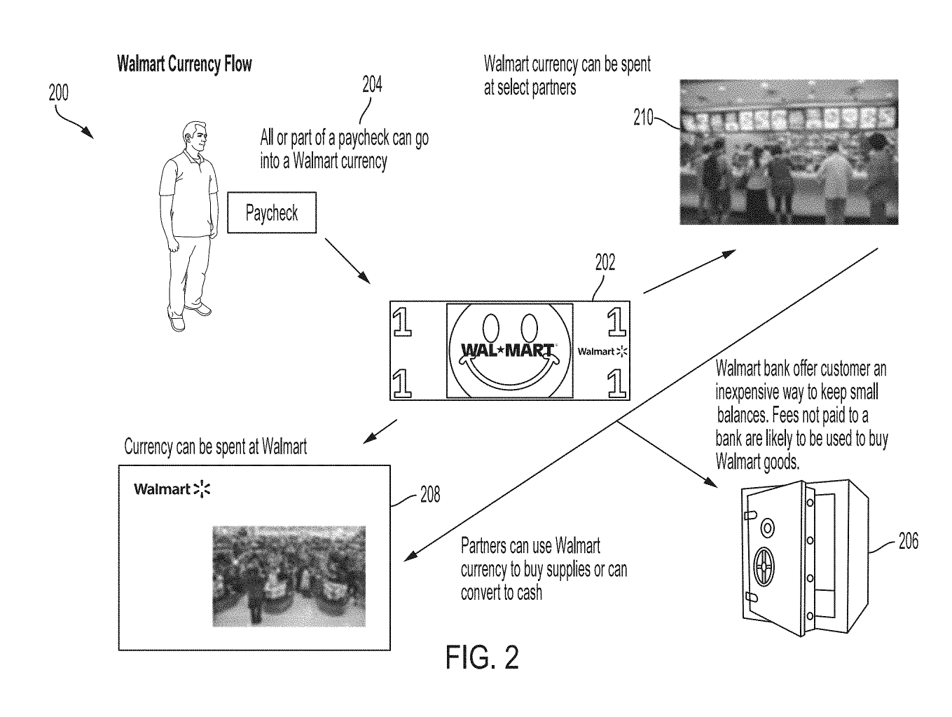

FIG. 2 illustrates an example ecosystem 200 of digital currency. The ecosystem may comprise a digital currency 202, a financial institution or an organization 204 that may issue paychecks or other forms of payments, an institution 206 that manages the digital currency 202, an organization 208 that issues the digital currency 202, and one or more partnering organizations 210 that partner with the organization 208 and accept the digital currency 202.

In the ecosystem 200, the digital currency 202 may be any form of digital currency, for example, virtual currency or cryptocurrency. The digital currency 202 may be issued by the organization 208 via the digital managing insinuation 206.

The paycheck or other form of payment 204 may be issued in regular physical money or other digital currencies, by for example an employer to its employees via the financial institution 204. The paycheck or other form of payment 204 may be transferred from the financial institution 204 to the digital managing institution 206 where all or part of the paycheck or other form of payment are converted into a corresponding amount of digital currency 202 in accordance with a specified exchange ratio (e.g., 1:1).

The digital managing institution 206 may be an independent third-party institution or an institution associated with the organization 208. The digital managing institution 206 may generate the digital currency 202, convert between the digital currency 202 and other forms of currencies, etc.

The organization 208 may be a retailer. The origination 208 may issue via the managing institution 206 the digital currency 202, such that the digital currency 202 can be used by customers in the organization 208, for example shopping goods or services provided by the organization 206.

The partnering organizations 210 may collaborate with or be selected by the organization 208 to accept the digital currency 202 for purchasing their products or services. The partnering organizations 210 may also use the digital currency 202 to purchase products or services from the organization 208, and may also cash out the digital currency 202 from the digital currency managing institution 206, for example converting digital currency to cash (e.g., US dollars). With the digital currency 202, customers may be offered an inexpensive way to keep a small balance. Fees paid to a regular bank on small balances may not be charged.

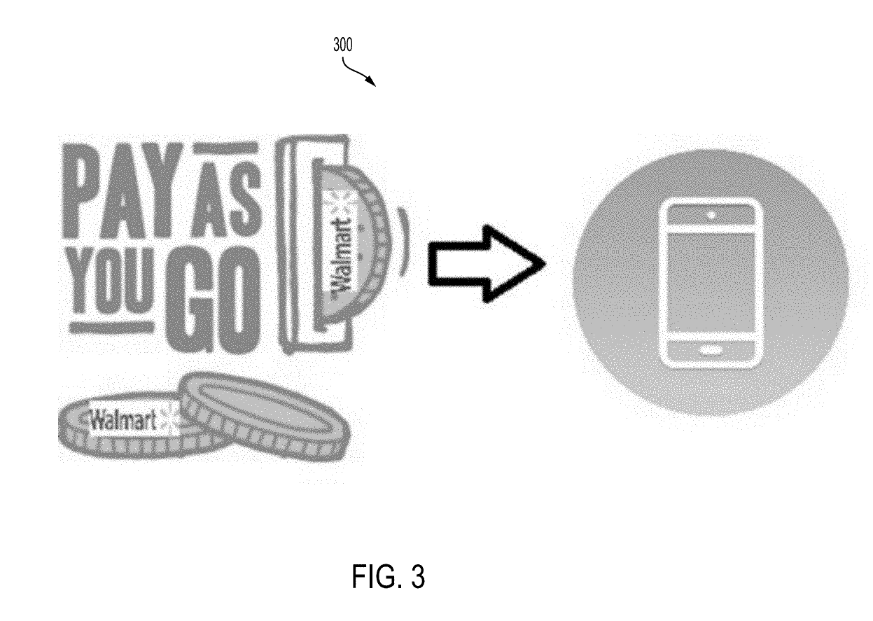

In some embodiments, digital currency can be used on the go, as shown in FIG. 3. Customers can pay or use digital currency via a mobile device, such as a smart phone, a tablet, or a computing pad.

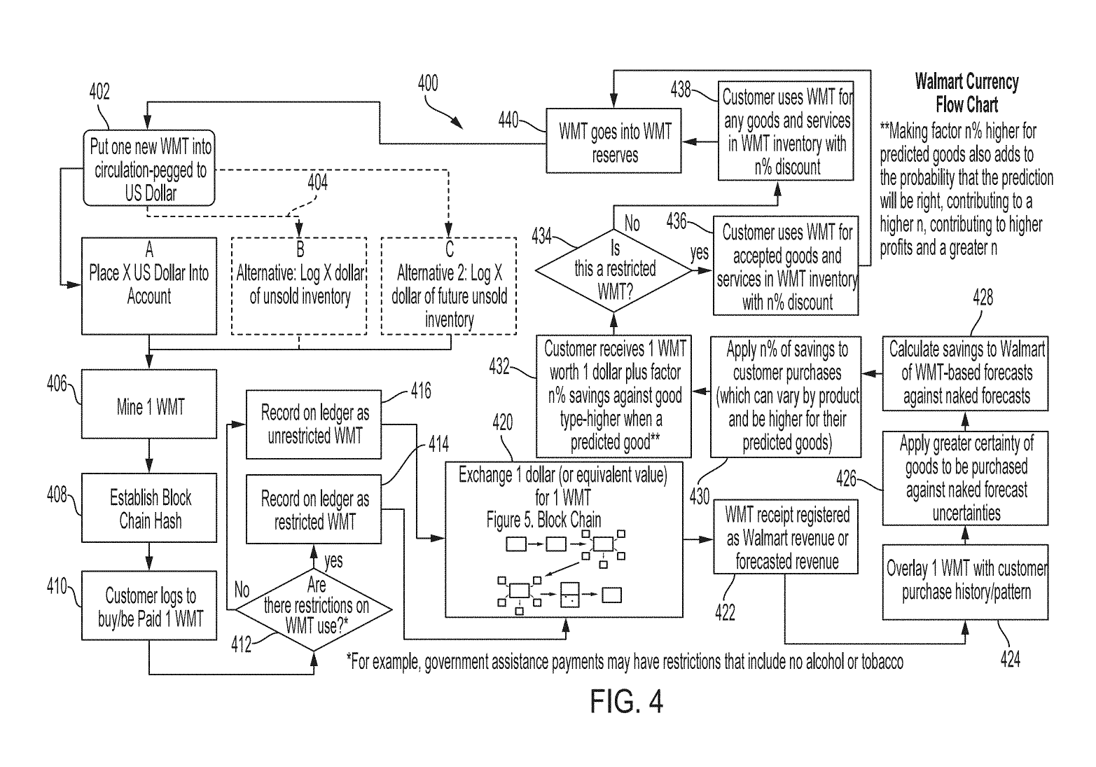

FIG. 4 illustrates flow chart of an example method 400 for circulating digital currency. The method 400 may comprise the following steps.

At step 402, one new digital currency unit may be put into circulation. The digital currency may be pegged to a regular currency. The regular currency as used herein may include national currencies (e.g., U.S. dollars) and cryptocurrencies.

At step 404, a certain amount of regular currency (e.g., US dollars) may be placed into account (404A). Alternatively, a certain amount of money of unsold inventory may be logged (404B). Also alternatively, a certain amount of regular currency of future unsold inventory may be logged (404C).

At step 406, digital currency may be mined or generated corresponding US dollars.

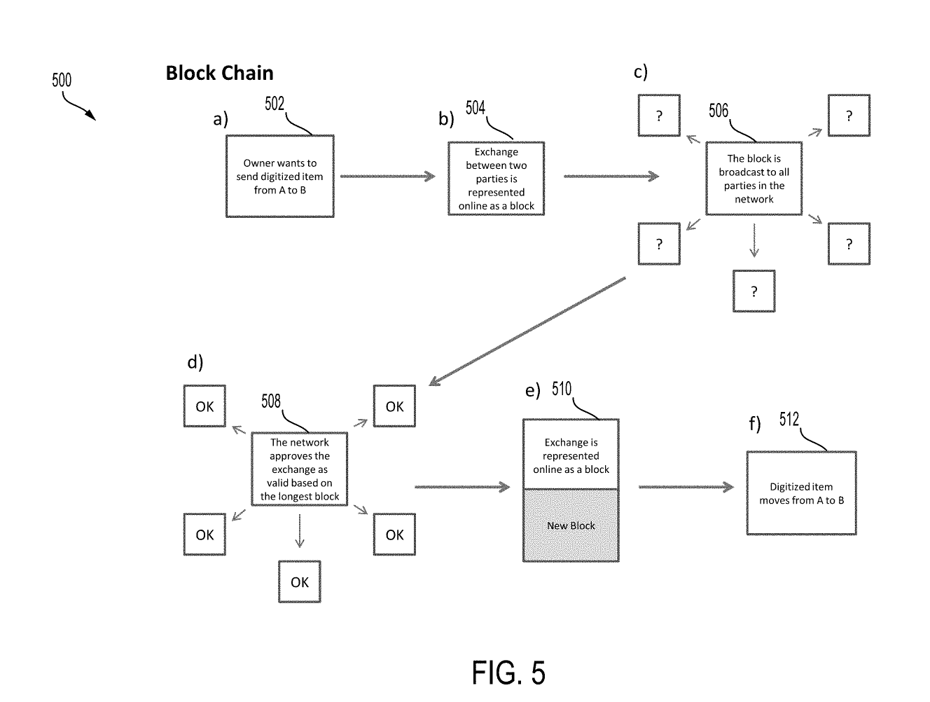

At step 408, the digital currency may be hashed into a block of a blockchain 420. An example of blockchain is shown in FIG. 5.

At step 410, a customer may log into an account to buy digital currency with US collars or may be paid with digital currency. For example, when the customer returns products, the customer may be paid the corresponding digital currency.

At step 412, it is determined whether there are any restrictions on the digital currency use. For example, the restrictions may be stored in a database and associated with the digital currency. In processing the transaction, the database is checked to determine if there is a restriction on the digital currency. The restrictions may be any form of resections, for example digital currency associated with government assistance payments may have restrictions that include no alcohol or tobacco.

If the digital currency is determined to be restricted for use, the digital currency may be recorded on the ledger of the blockchain as restricted digital currency (step 414). For example, the restricted digital currency may only be used to buy food, not alcohol.

If the digital currency is determined to be unrestricted for use, the digital currency may be recorded on the ledger of the blockchain as unrestricted digital currency (step 416). For example, the unrestricted digital currency may be used to buy anything sold at retailers or selected partners.

At step 422, receipt of digital currency may be registered as digital revenue or forecasted revenue for an entity.

At step 424, the digital currency may be overlaid with customer purchase history. For example, a customer may buy digital currency at the beginning of each month. A smart analysis AI (artificial intelligence) may help the customer to buy according to his budget, values, affinities, and preferences.

At step 426, greater certainty of goods to be purchased may be applied against naked forecast uncertainties. For example, the purchase or payment in one unit of currency can be logged as revenue or future revenue since it will (or would be highly likely) to be spent at digital versus elsewhere. Customer purchase history may further be considered as a way to make more accurate forecasts, which can lead to savings n over the naked forecasts.

At step 428, savings compared to naked forecast can be calculated. For example, a saving factor n % may be generated. Some of n can go to the customer using the digital currency, which in effect makes the currency more valuable at a retailer than the equivalent dollar used for the exchange, a win-win for the retailer and the customer. The savings can be different by product type to factor in differences in margins and differences in the impact of improved forecasts. The savings can be greater when the customer buys goods that are on their shopping history and are therefore predicted, which has the added effect of helping predictions to come true, making forecasts more accurate, and creating a larger savings further making the digital currency a more attractive option for customers, and overall creating a positive cascade

At step 430, n % of savings to customer purchases may be applied. Again, n % can vary by product and be higher for their predicted goods.

At step 432, customer receives one digital current unit worth 1 dollar plus the saving factor n % against good type. Factor n % can be made higher for predicted goods, may also add to the probability that the prediction will be right, contributing to a higher n, contributing to higher profits, and a greater n.

At step 434, it is inquired whether the digital currency is restricted. If “Yes”, customer may use the restricted digital currency for accepted goods and services in retailer inventory with the n % discount (step 436). If “No”, the customer can use the digital currency for any goods and services in retailor inventory with the n % discount (step 438).

At step 440, the digital currency paid by the customer may go into digital currency reserve for next circulation.

FIG. 5 illustrates an example transfer process 500 of a digital currency via a blockchain, in according to one embodiment. The process 500 may comprise the following steps.

At step 502, owner A may want to send digital currency to owner B.

At step 504, the exchange of digital currency between owner A and owner B may be hashed into a block of the blockchain.

At step 506, the block in which the exchange of digital currency is stored, may be broadcast to all parties involved in the blockchain. The blockchain is associated with a peer-to-peer network comprising of a set of parties.

At step 508, the exchange is approved by the network based on the longest blockchain. The exchange may be approved by at least 50% of all the parties of the network.

At step 510, upon approval of the exchange, the exchange can be stored as a new block added to the longest blockchain.

At step 512, the digital currency is moved from owner A to owner B.

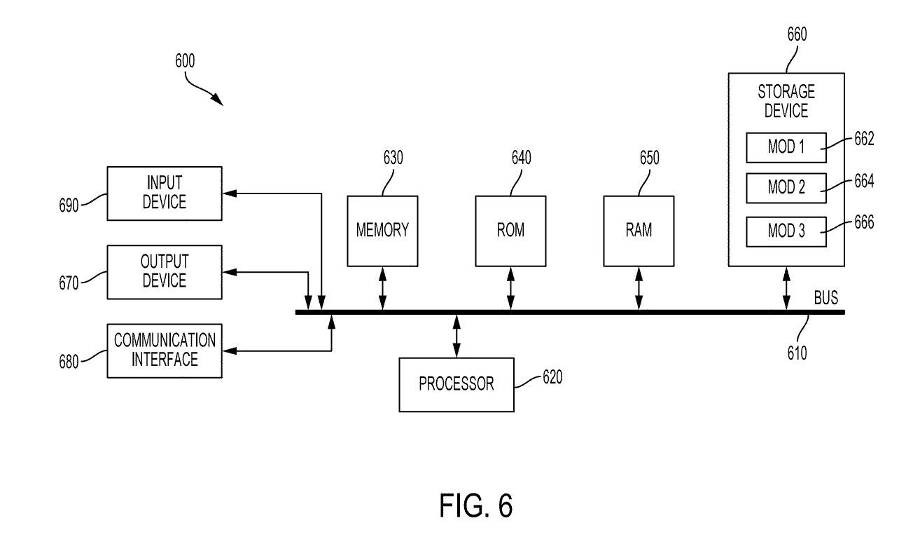

With reference to FIG. 6, an exemplary system 600 can include a processing unit (CPU or processor) 620 and a system bus 610 that couples various system components including the system memory 630 such as read only memory (ROM) 640 and random access memory (RAM) 650 to the processor 620. The system 600 can include a cache of high speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
generating one digital currency unit by tying the one digital currency unit to a regular currency;
storing information of the one digital currency unit into a block of a blockchain;
buying or paying the one digital currency unit;
determining whether restrictions are applied to the one digital currency unit by referring to one or more documents associated with the one digital currency;
recording the determination in a block of the blockchain;
overlaying the one digital currency unit with customer purchase history;
calculating savings based on the one digital currency unit again naked forecast;
applying the savings to customer purchases;
using the one digital currency unit for accepted goods or services with the saving if the one digital currency unit is restricted;
using the one digital currency unit for any goods or services with the saving if the one digital currency unit is unrestricted; and
storing the one digital currency into a digital currency reserve.

2. The method of claim 1, wherein the regular currency is U.S. dollar.

3. The method of claim 1, the method further comprising:
recording the digital currency unit as a restricted digital currency unit when the digital currency unit is determined as restricted; and
recording the digital currency unit as an unrestricted digital currency unit when the digital currency unit is determined as unrestricted.

4. The method of claim 1, further comprising:
applying greater certainty of goods to be purchased against naked forecast uncertainties.

5. The method of claim 1, wherein the savings vary by products and is higher for predicted goods of the customer.

6. The method of claim 1, further comprising:
receiving the one digital currency unit worth one US dollar plus the savings against good type.

7. A system, comprising:
a processor; and
a computer-readable storage medium having instructions stored which, when executed by the processor, cause the processor to perform operations comprising:
generating one digital currency unit by tying the one digital currency unit to a regular currency;
storing information of the one digital currency unit into a block of a blockchain;
buying or paying the one digital currency unit;
determining whether restrictions are applied to the one digital currency unit by checking a database in which restrictions associated with the one digital currency are stored;
recording the determination in a block of the blockchain;
overlaying the one digital currency unit with customer purchase history;
calculating savings based on the one digital currency unit again naked forecast;
applying the savings to customer purchases;
using the one digital currency unit for accepted goods or services with the saving if the one digital currency unit is restricted;
using the one digital currency unit for any goods or services with the saving if the one digital currency unit is unrestricted; and
storing the one digital currency into a digital currency reserve.

8. The system of claim 7, wherein the regular currency is U.S. dollar.

9. The system of claim 7, the computer-readable storage medium having additional instruction stored which, when executed by the processor, cause the processor to perform operations comprising:
recording the digital currency unit as a restricted digital currency unit when the digital currency unit is determined as restricted; and
recording the digital currency unit as an unrestricted digital currency unit when the digital currency unit is determined as unrestricted.

10. The system of claim 7, the computer-readable storage medium having additional instruction stored which, when executed by the processor, cause the processor to perform operations comprising:
applying greater certainty of goods to be purchased against naked forecast uncertainties.

11. The system of claim 7, wherein the savings vary by products and is higher for predicted goods of the customer.

12. The system of claim 7, the computer-readable storage medium having additional instruction stored which, when executed by the processor, cause the processor to perform operations comprising:
receiving the one digital currency unit worth one US dollar plus the savings against good type.

13. A non-transitory computer-readable storage medium having instructions stored which, when executed by a computing device, cause the computing device to perform operations comprising:
generating one digital currency unit by tying the one digital currency unit to a regular currency;
storing information of the one digital currency unit into a block of a blockchain;
buying or paying the one digital currency unit;
determining whether restrictions are applied to the one digital currency unit by checking a database in which restrictions associated with the one digital currency are stored;
recording the determination in a block of the blockchain;
overlaying the one digital currency unit with customer purchase history;
calculating savings based on the one digital currency unit again naked forecast;
applying the savings to customer purchases;
using the one digital currency unit for accepted goods or services with the saving if the one digital currency unit is restricted;
using the one digital currency unit for any goods or services with the saving if the one digital currency unit is unrestricted; and
storing the one digital currency into a digital currency reserve.
